(19) United States
(12) Patent Application Publication
(10) Pub. No.: US 2016/0196236 A1
(43) Pub. Date: Jul. 7, 2016

(54) METHOD FOR ESTIMATING AND PREDICTING PARAMETERS OF EXPONENTIATED WEIBULL MODEL

(71) Applicant: UMM AL-QURA UNIVERSITY, Makkah (SA)

(72) Inventor: Mashail M. AL SOBHI, Makkah (SA)

(73) Assignee: UMM AL-QURA UNIVERSITY, Makkah (SA)

(21) Appl. No.: 14/990,616

(22) Filed: Jan. 7, 2016

Related U.S. Application Data
(60) Provisional application No. 62/100,760, filed on Jan. 7, 2015.

(51) Int. Cl. G06F 17/18; G06F 17/50

(52) U.S. Cl. CPC G06F 17/18; G06F 17/5009

(57) ABSTRACT

Discussed herein are a computing device and an associated method for computing Bayesian estimation for shape parameters and reliability function of the exponentiated Weibull distribution based on dual generalized order statistics. Metropolis-Hastings algorithm is employed for computing Bayes estimates. Estimated risks for both the Bayes and ML estimates of the shape parameters (and reliability function) indicate that the estimated risks of the estimates decrease as the sample size increases and the Bayes estimates have the smallest estimated risks as compared with their corresponding maximum likelihood estimates. Furthermore, Bayesian prediction bounds for future lower record values are computed based on dual generalized order statistics.

### INCORPORATION BY REFERENCE

The present disclosure claims the benefit of U.S. Provisional Application No. 62/100,760, filed on Jan. 7, 2014, which is incorporated herein by reference in its entirety.

### BACKGROUND

The background description provided herein is for the purpose of generally presenting the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Dual generalized order statistics (DGOS) is a unification of several models of discerningly ordered random variables such as reversed ordered order statistics, lower—k record statistics and Pfeifer records. The Weibull distribution is a popular distribution with a wide variety or real-world applications. For instance, the Weibull model can be used to analyze the breaking strength of materials. Additionally, the Weibull model has been widely used for analyzing lifetime data. However, while this distribution is quite adequate for modeling phenomenon with monotone failure rates, it is not useful for modeling applications that have a non-monotone failure rate.

The bath-tub shaped and the unimodal failure rates that are common in reliability studies and biological studies cannot be modeled by the Weibull distribution. An example of bath-tub shaped failure rate is the human mortality experience with a high infant mortality rate which reduces rapidly to reach a low. It then remains at that level for quite a few years before picking up again. Unimodal failure rates can be observed in course of a disease whose mortality reaches a peak after some finite period and then declines gradually.

Accordingly, an exponentiated Weibull model is required for the above stated applications. The exponentiated Weibull model (EWM) was introduced by Mudholkar and Sirvastava in “Exponentiated Weibull family for analyzing bathtub failure-rate data”, IEEE Transaction on Reliability, vol. 42, 99-302, and incorporated herein by reference in its entirety, as an extension of the Weibull family of distributions by adding an additional shape parameter. Mudholkar and Huston described in “The exponentiated Weibull family: Some properties and a flood data application”, Communications in Statistics-Theory and Methods, Vol. 25, 3059-3083, 1996, and incorporated herein in its entirety, that the density function of the EWM is decreasing when the product of the shape parameters is less than one and that the density function is unimodal when the product of the shape parameters is greater than one.

Further, some statistical properties of the EWM are described in the work of Jiang and Murthy, “The exponentiated Weibull family: a graphical approach” IEEE Transaction on Reliability, Vol. 48(1), 68-72, 1999, and incorporated herein by reference in its entirety, and in the works of Nassar and Eissa, in “Bayesian estimation for the exponentiated Weibull model”, Communication in Statistics—Theory and Methods, Vol. 33, 2343-2362, 2004 and incorporated herein by reference in its entirety. In this work, Bayes estimators for the two shape parameters, reliability and failure rate functions of the EWM were obtained based on type-II censored data and complete samples.

The work conducted by Choudhury in “A simple derivation of moments of the exponentiated Weibull distribution”, Metrika, Vol. 62, 17-22, 2005, incorporated herein by reference in its entirety, proposed a simple derivation for the moments of the EWM. The work of Singh et al. in “Estimation of three-parameter exponentiated-Weibull distribution under type-II censoring”, Journal of Statistical Planning and Inference, vol. 134, 350-372, 2004, and incorporated herein in its entirety, derived maximum likelihood and Bayesian estimates for the two and three parameters of the EWM based on type-II censored samples. Further, Pal et al. introduced several properties and obtained some inferences for the three parameter EWM in “Exponentiated Weibull distribution”, Statistica, vol. anno LXVI, no: 2, 139-147, 2006, and incorporated herein by reference in its entirety. Kim et al. described in “Bayesian estimation for the exponentiated Weibull model under Type II progressive censoring”, Statistical Papers, Published on line: 6 Feb. 2009, incorporated herein by reference in its entirety, a technique to obtain the maximum likelihood and Bayes estimators for the two shape parameters and the reliability function of the EWM based on progressive type-II censored sample.

However, the above mentioned works fail to describe a technique of computing the shape parameters of the exponentiated Weibull model based on generalized order statistics. Accordingly, the present disclosure provides for a method of computing the shape parameters and reliability function of the EWM based on DGOS. Furthermore, the present disclosure provides for a technique of predicting Bayesian bounds for DGOS based on a Markov Chain Monte Carlo method. Accordingly, computing the parameters (and reliability function) based on DGOS provides the advantageous ability of representing a unification of models of decreasingly ordered random variables e.g. lower record models and the like.

### SUMMARY

The present disclosure describes a technique for computing Bayesian estimates of two shape parameters and a reliability function of an exponentiated Weibull model based on dual generalized order statistics (DGOS). Further, Bayesian prediction bounds for future DGOS from exponentiated Weibull model are computed, wherein both symmetric and asymmetric loss functions are considered for Bayesian computations. The Markov chain Monte Carlo (MCMC) method is used for computing the Bayes estimates and prediction bounds. The results obtained from the MCMC algorithm are specialized to lower record values and a comparison of the Bayesian estimators is performed with respect to maximum likelihood estimators.

According to one embodiment, there is provided a method of estimating shape parameters and a reliability function of an exponentiated Weibull model (EWM) based on dual generalized order statistics of the model, the method comprising: assigning an initial value for each of a first shape parameter and a second shape parameter of the EWM; generating by circuitry, a predetermined number of samples for each of the first shape parameter and the second shape parameter based on a first conditional posterior distribution of the first shape parameter with respect to the second shape parameter and a second conditional posterior distribution of the second shape parameter with respect to the first shape parameter; calculating based on the generated samples and a burn-in period, Bayesian estimates of the first shape parameter, the second shape parameter, and the reliability function of the EWM corresponding to a loss function; computing by circuitry, maximum likelihood estimates of the first shape parameter, the second shape parameter and the reliability function of the EWM; computing squared error deviations for each of the computed Bayesian estimates and maximum likelihood estimates; and computing an estimated risk of the first shape parameter, the second shape parameter and the reliability function based on the computed squared error deviations.

According to another embodiment, there is provided a non-transitory computer-readable medium having stored thereon a program that, when executed by a computer, causes the computer to execute a method that includes: assigning an initial value for each of a first shape parameter and a second shape parameter of the EWM; generating a predetermined number of samples for each of the first shape parameter and the second shape parameter based on a first conditional posterior distribution of the first shape parameter with respect to the second shape parameter and a second conditional posterior distribution of the second shape parameter with respect to the first shape parameter; calculating based on the generated samples and a burn-in period, Bayesian estimates of the first shape parameter, the second shape parameter, and the reliability function of the EWM corresponding to a loss function; computing maximum likelihood estimates of the first shape parameter, the second shape parameter and the reliability function of the EWM; computing squared error deviations for each of the computed Bayesian estimates and maximum likelihood estimates; and computing an estimated risk of the first shape parameter, the second shape parameter and the reliability function based on the computed squared error deviations.

According to one aspect of the present disclosure is provided a device for estimating shape parameters and a reliability function of an exponentiated Weibull model (EWM) based on dual generalized order statistics of the model. The device comprises circuitry configured to: assign an initial value for each of a first shape parameter and a second shape parameter of the EWM; generate a predetermined number of samples for each of the first shape parameter and the second shape parameter based on a first conditional posterior distribution of the first shape parameter with respect to the second shape parameter and a second conditional posterior distribution of the second shape parameter with respect to the first shape parameter; calculate based on the generated samples and a burn-in period, Bayesian estimates of the first shape parameter, the second shape parameter, and the reliability function of the EWM corresponding to a loss function; compute maximum likelihood estimates of the first shape parameter, the second shape parameter and the reliability function of the EWM; compute squared error deviations for each of the computed Bayesian estimates and maximum likelihood estimates; and compute an estimated risk of the first shape parameter, the second shape parameter and the reliability function based on the computed squared error deviations.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates according to an embodiment, a flowchart depicting the steps performed to compute Bayes estimate for a function of the shape parameters;

FIG. 2 depicts an exemplary flowchart illustrating the steps performed in computing a Bayes prediction value for a future observation;

FIG. 3 depicts according to an embodiment, a flowchart illustrating the steps performed in a Monte-Carlo simulation; and

FIG. 4 illustrates a block diagram of a computing device according to an embodiment.

### DETAILED DESCRIPTION OF EMBODIMENTS

Generalized order statistics are a unifying distribution theoretical setup for models of ordered random variables, such as ordered statistics and record values. Alternatively, generalized order statistics may also be defined via products of random variables with power function distributions. For instance, consider a product of beta-random variables, each having a probability density function g(x) as follows:

$$g ( x ) = \frac{{x}^{a - 1} - {( 1 - x )}^{b - 1}}{B ( a , b )} 0 < x < 1 \qquad ( 1 a )$$

wherein, B(a, b) denotes the beta distribution with parameters a>0, b>0. A generalized order statistic is defined as follows: for some distribution function F, and a set of positive numbers γ₁, γ₂, γ₃ . . . γₙ and a set of independent random variable B₁, B₂, B₃ . . . Bₙ with, Bⱼ˜Beta (γⱼ, 1), the random variables expressed as:

X^{r}=F⁻¹(1−Πⱼ₌₁^{r}Bⱼ) 1≦r≦n (1b)

are referred to generalized order statistics based on F and the set of number γ₁, γ₂, γ₃ . . . γₙ.

According to one embodiment of the present disclosure, for a random sample drawn from an absolutely continuous distribution function (cdf) F, with corresponding probability density function (pdf)t the joint density function of the first r (out of n) dual generalized order statistics (DGOS): X (l,n,m,k), . . . X(r,n,m,k) can be expressed as:

$${f}^{X ( 1 , n , m , k ) , … , X ( r , n , m , k )} ( {x}_{1} , … , {x}_{r} ) = {C}_{r - 1} ( {\prod }_{j = 1}^{r - 1} {( F ( {x}_{j} ) )}^{m} f ( {x}_{j} ) ) {( F ( {x}_{r} ) )}^{{γ}_{r} - 1} f ( {x}_{r} ) , \qquad ( 1 c )$$

on the cone F⁻¹(0)≦x₁≦ . . . ≦xₜ≦F⁻¹(1) with parameters nεN, n≧2, k and m are integers: k>0, m≧−1, such that the following condition holds true for all iε(1, 2, 3, . . . r−1):

$${C}_{r - 1} = {\prod }_{j = 1}^{r} {γ}_{j} \cdot {γ}_{i} = k + ( n - i ) ( m + 1 ) > 0 \qquad ( 1 d )$$

Suppose that a sequence of independent identically distributed (i.i.d) random variables X₁, X₂, X₃ . . . , Xₙ has a cumulative distribution function F(x). Let Yₙ be a function defined as: Yₙ=max (min) {X₁, X₂, X₃, . . . Xn} for n>1. An upper (and correspondingly lower) record value is defined herein as the value X of {Xₙ, n≧1}, if Yⱼ is greater than (and correspondingly lower than) Yⱼ₋₁ for all j>1. Note that the upper record values can be transformed into lower record values by replacing the original sequence of {Xⱼ} by {−Xⱼ}.

Turning to equation (1c), lower record values can be obtained from the DGOS scheme as a special case by making the following substitution: m=−1 and k=1. Accordingly, the exponentiated Weibull model (EWM) that is an extension of the Weibull family of distributions can be obtained by adding an additional shape parameter. The probability distribution function (pdf), represented as f(x), cumulative distribution function (cdf), represented as F(x) and reliability function S(t) of the EWM can be expressed as:

f(x)=αθx^{α-1}e^{-x}^{^{α}})^{θ-1}, x>0,α,θ>0. (2)

F(x)=(1−e^{-x}^{^{α}})^{θ},x>0, (3)

S(t)=1−(1−e^{-t}^{^{α}})^{θ}, (4)

where α and θ are the shape parameters of the exponentiated Weibull model.

According to one embodiment of the present disclosure is provided a technique for estimating the shape parameters of the EWM via maximum likelihood estimation. Assuming that X (l,n,m,k) and X(r,n,m,k) are r generalized order statistics drawn from the EWM distribution, the likelihood function l(α, θ), can be obtained by substituting equations (2) and (3) into equation (1c) to obtain:

$$𝓁 ( α , θ \vert x ) ∝ {α}^{r} {θ}^{r} {\prod }_{j = 1}^{r} {v}_{j} {u}_{j}^{θ} {\prod }_{j = 1}^{r - 1} {u}_{j}^{θ m} {u}_{r}^{θ ( {γ}_{r} - 1 )} , \qquad ( 5 )$$

where x=(x₁, x₂, x₃, . . . , xₙ) and j=1, 2, 3, . . . , r and the parameters νⱼ and uⱼ are given by:

$${v}_{j} ≡ {v}_{j} ( α ) = \frac{{x}_{j}^{α - 1} {e}^{- {x}_{j}^{α}}}{{u}_{j}} , \\ {u}_{j} ≡ {u}_{j} ( α ) = 1 - {e}^{- {x}_{j}^{α}} , \qquad ( 6 )$$

The natural logarithm of the likelihood function of equation (5) is given by:

$$L ∝ r ln α + r ln θ + {\sum }_{j = 1}^{r} [ ln {v}_{j} + θ ln {u}_{j} ] + m θ {\sum }_{j = 1}^{r - 1} ln {u}_{j} + θ ( {γ}_{r} - 1 ) ln {u}_{r} \qquad ( 7 )$$

Differentiating equation (7) with respect to parameters α and θ and equating the results to zero, the likelihood equations for the parameters α and θ can be obtained as:

$$\begin{matrix}\frac{\partial L}{\partial α} = \frac{r}{α} + {\sum }_{j = 1}^{r} [ {η}_{1 j} ( α ) + ( θ - 1 ) {η}_{2 j} ( α ) ] + θ m {\sum }_{j = 1}^{r - 1} {η}_{2 j} ( α ) + θ ( {γ}_{r} - 1 ) {η}_{2 r} ( α ) = 0 , & ( 8 ) \\ \frac{\partial L}{\partial θ} = \frac{r}{θ} + {\sum }_{j = 1}^{r} ln {u}_{j} + m {\sum }_{j = 1}^{r - 1} ln {u}_{j} + ( {γ}_{r} - 1 ) ln {u}_{r} = 0 , & ( 9 )\end{matrix}$$

wherein, for j=1, 2, 3, . . . r, the following equations hold true:

η₁ⱼ(α)=(1−xⱼ^{α})ln xⱼ,

η₂ⱼ(α)=νⱼ ln xⱼ, (10)

Thus, according to an embodiment, the maximum likelihood (ML) estimates of the parameters α and θ can be computed by solving the two non-linear likelihood equations (8) and (9) using, for example, a Newton-Raphson iteration scheme. The Newton-Raphson numerical method is a technique for finding better approximations of roots (or zeroes) of a real valued function. The corresponding maximum likelihood (ML) estimate of the reliability function S(t) can be computed from equation (4) after replacing α and θ by their ML estimates.

According to one embodiment, the asymptotic variance-covariance matrix of the MLE estimates for the two parameters α and θ is computed based on the inverse of the Fisher information matrix (i.e., a method of measuring the amount of information that an observable random variable carries about an unknown parameter upon which the probability of the random variable depends), after ignoring the expectation operators as follows:

$$[ \begin{matrix}var ( \hat{α} ) & cov ( \hat{α} , \hat{θ} ) \\ cov ( \hat{α} , \hat{θ} ) & var ( \hat{θ} )\end{matrix} ] = {[ \begin{matrix}- \frac{{\partial }^{2} L}{\partial {α}^{2}} & - \frac{{\partial }^{2} L}{\partial α \partial θ} \\ - \frac{{\partial }^{2} L}{\partial θ \partial α} & - \frac{{\partial }^{2} L}{\partial {θ}^{2}}\end{matrix} ]}_{\hat{α} , \hat{θ}}^{- 1} \qquad ( 11 )$$

wherein, the following conditions hold true:

$$\begin{matrix}\frac{{\partial }^{2} L}{\partial {α}^{2}} = - \frac{r}{{α}^{2}} + θ m {\sum }_{j = 1}^{r - 1} {δ}_{j} + ( {γ}_{r} - 1 ) {θδ}_{r} - {\sum }_{i = 1}^{r} {x}_{i}^{α} {ln}^{2} {x}_{i} + {\sum }_{i = 1}^{r} ( θ - 1 ) {δ}_{j} , & ( 11 a ) \\ \frac{{\partial }^{2} L}{\partial {θ}^{2}} = - \frac{r}{{θ}^{2}} , & ( 11 b ) \\ \frac{{\partial }^{2} L}{\partial α \partial θ} = \frac{{\partial }^{2} L}{\partial θ \partial α} = {\sum }_{j = 1}^{r} {η}_{2 j} ( α ) + m {\sum }_{j = 1}^{r - 1} {η}_{2 j} ( α ) + ( {γ}_{r} - 1 ) {η}_{2 r} ( α ) , \\ where , & ( 11 c ) \\ {δ}_{j} = {θη}_{2 j} ( α ) ( {η}_{1 j} ( α ) - {η}_{2 j} ( α ) ) & ( 11 d )\end{matrix}$$

Note that according to an embodiment, the asymptotic variance-covariance matrix can be used to compute the asymptotic confidence intervals (1−τ). 100% for the parameters α and θ, respectively as follows:

\hat{α}_{ML}±≈τ/2\sqrt{var(\hat{α}_{ML})} and \hat{θ}_{ML}±≈τ/2\sqrt{var(\hat{θ}_{ML})}

According to one embodiment, in order to compute the shape parameters of the EWM by a Bayesian approach, the performance of the Bayesian estimates of the shape parameters depends on the prior information about the unknown parameters and the loss function assumed. The prior information can be expressed for instance by the experimenter, who has some knowledge about the unknown parameters and their statistical distributions.

According to one embodiment, a squared error loss (SEL) function that is symmetric in nature can be used as the loss function. Additionally, according to another embodiment, an asymmetric loss function known as the linear exponential loss function (LINEX) can be used. The LINEX function rises approximately exponentially on one side of zero, and approximately linearly on the other side. Assuming that the minimal loss occurs at \hat{ω}=ω, the LINEX loss function for ω=(α, β) can be expressed as:

L₁(δ)∝(e^{aδ}−aδ−1); a≠0, (12)

where δ=(\hat{ω}ω) and \hat{ω} is an estimate of co.

The sign and magnitude of ‘a’ represents the direction, and degree of symmetry respectively. Specifically, the case for a>0, implies that overestimation is more serious than underestimation, and a<0 indicates the contrary. Thus, for the case of ‘a’ close to zero, the LINEX loss function is approximately the squared error loss and thus almost symmetric.

The posterior s-expectation of the LINEX loss function of equation (12) is:

E_{ω}=(L₁(\hat{ω}−ω))∝(exp(aω)·E_{ω}[ exp(−aω)]−a·(\hat{ω}−E_{ω}[ω])−1), (13)

where E_{ω} is equivalent to the posterior s-expectation with respect to the posterior pdf (ω). According to one embodiment, the Bayes estimator \hat{ω}_{BL} of ω under the LINEX loss function is the value of \hat{ω} that minimizes equation (13) and can be expressed as follows:

$${\hat{ω}}_{BL} = - \frac{1}{a} ln ( {E}_{ω} [ exp ( - a ω ) ] ) , \qquad ( 14 )$$

Note that equation (14) is true as long as the following expectation exists: i.e., E_{ω}[ exp(−αω)] exists and is finite. Further, the prior knowledge of the shape parameters α and θ, is represented by the following conditional bivariate prior distribution given as follows:

π(α,θ)=π₁(α)π₂(θ) (15)

where π₁(α) and π₂(θ) are respectively expressed as follows:

$$\begin{matrix}{π}_{1} ( α ) = \frac{1}{c} , 0 < α < c , & ( 16 ) \\ {π}_{2} ( θ ) ∝ \frac{1}{θ} , θ > 0. & ( 17 )\end{matrix}$$

The joint posterior pdf of the shape parameters α and θ (represented as π*(α, θ)) can be computed from equation (5) and (17) and expressed as:

$$\begin{matrix}{π}^{*} ( α , θ \vert x ) = {k}_{1}^{- 1} {α}^{r} {θ}^{r - 1} {\prod }_{j = 1}^{r} {v}_{j} {e}^{- θ T ( m ; α )} , \\ where & ( 18 ) \\ {k}_{1} = Γ ( r ) {\int }_{0}^{c} {{α}^{r} [ T ( m ; α ) ]}^{- r} d α , \\ and & ( 19 ) \\ T ( m ; α ) = - ( m + 1 ) {\sum }_{j = 1}^{r - 1} ln {u}_{j} - {γ}_{r} ln {u}_{r} & ( 20 )\end{matrix}$$

According to one embodiment, using the SEL loss function and using equation (14), the Bayes estimates for the function ω≡ω(α,β)=α, θ or S(t) is given as follows:

$${\hat{ω}}_{BS} = {k}_{1}^{- 1} {\int }_{0}^{∞} {\int }_{0}^{c} {ωα}^{r} {θ}^{r - 1} {\prod }_{j = 1}^{r} {v}_{j} {e}^{- θ T ( m ; α )} d α d θ , \qquad ( 21 )$$

Further, according to another embodiment, based on the LINEX loss function, the Bayes estimate for the function w can be obtained from equation (15) as:

$${\hat{ω}}_{BL} = - \frac{1}{a} ln [ {k}_{1}^{- 1} {\int }_{0}^{∞} {\int }_{0}^{c} {e}^{- a ω} {α}^{r} {θ}^{r - 1} {\prod }_{j = 1}^{r} {v}_{j} {e}^{- θ T ( m ; α )} d α d θ ] \qquad ( 22 )$$

where φ₁(α, β) is given by equation (20). Note from equation (20) and (22), the Bayes estimate of a function includes integrals and thus cannot be computed analytically. Therefore, according to one embodiment, numerical integration techniques are used for computing the Bayes estimates.

In what follows, a description is provided of Markov-Chain-Monte Carlo (MCMC) method to compute Bayesian estimates of the function w≡(α,θ). According to an embodiment, Metropolis Hastings algorithm is used to generate samples from the conditional posterior distributions and then compute the Bayes estimates. The Metropolis Hastings algorithm generates samples from an arbitrary proposal distribution (i.e., a Markov transition model). The conditional posterior distributions of the parameters α and θ can be computed as follows:

$$\begin{matrix}{π}_{1}^{*} ( α \vert θ , x ) ∝ {α}^{r} {\prod }_{j = 1}^{r} {v}_{j} {e}^{- θ T ( m ; α )} , & ( 23 ) \\ {π}_{2}^{*} ( θ \vert α , x ) ∝ {θ}^{r - 1} {e}^{- θ T ( m ; α )} & ( 24 )\end{matrix}$$

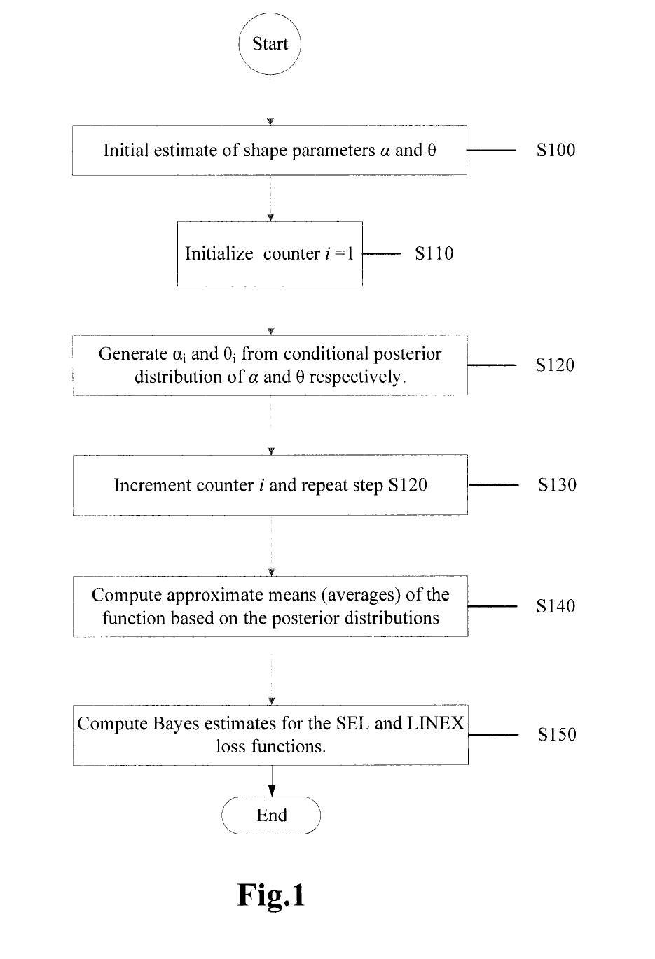

FIG. 1 depicts a flowchart illustrating the steps performed to compute the Bayes estimate for the function ω≡ω(α,θ) by the MCMC method.

In step S100, the process starts with an initial estimate of the shape parameters α and θ. By one embodiment, the initial estimates can be randomly assigned and denoted as α₀ and θ₀, respectively.

In step S110, the value of the counter i is initialized to one. The process then proceeds to step S120 wherein, the value of parameter α (and θ) at each level of iteration (denoted by αᵢ and θᵢ, respectively) are generated based on the conditional posterior distributions expressed in equations (23) and (24). Specifically, αᵢ is generated based on the conditional posterior distribution as stated in equation (23), and θᵢ is generated based on the conditional posterior distribution expressed in equation (24).

The process then proceeds to step S130 wherein the value of the counter i is incremented and the process in step S120 is repeated. By one embodiment, the step S130 is performed N times, wherein N is a predetermined integer.

In step S140, the mean (i.e., average) of the functions ω(α,θ) and exp (−αω(α,θ)) are computed as follows:

$$E ( ω \vert x ) = \frac{1}{N - M} {\sum }_{i = M + 1}^{N} ω ( {α}_{i} , {θ}_{i} ) , \\ E [ exp ( - a ω ) \vert x ] = \frac{1}{N - M} {\sum }_{i = M + 1}^{N} exp ( - a ω ( {α}_{i} , {θ}_{i} ) ) \qquad ( 24 a )$$

wherein, the parameter M is a burn-in period of the MCMC. Specifically, the burn in period corresponds to the number of initial iterations that are ignored (i.e., not considered) in the estimation of the parameters and the reliability function.

The process then proceeds to step S150, wherein the Bayes estimates of the function ω(α,θ) are computed for each loss function (SEL and LINEX) based on the computed averages of step S140. Specifically, the Bayes estimators corresponding to the SEL and the LINEX loss functions are computed as follows:

$$\begin{matrix}{\hat{ω}}_{BS} = E ( ω \vert x ) & ( 25 ) \\ {\hat{ω}}_{BL} = - \frac{1}{a} ln [ E [ exp ( - a ω ) \vert x ] & ( 26 )\end{matrix}$$

According to one embodiment of the present disclosure, based on the informative (first r out of n) DGOS X(l, n, m, k) and X(r, n, m, k) of the EWM distribution, Bayesian prediction for a future observation X(s, n, m, k) is computed. The conditional probability distribution of Xₛ=X(s, n, m, k) given Xᵣ=X(r, n, m, k) can be expressed as follows:

$$\begin{matrix}{f}_{1}^{*} ( {x}_{s} \vert {x}_{r} ) = {{{\frac{{k}^{s - r}}{( s - r - 1 ) !} [ ln F ( {x}_{r} ) - ln F ( {x}_{s} ) ]}^{s - r - 1} [ F ( {x}_{s} ) ]}^{k - 1} [ F ( {x}_{r} ) ]}^{- k} f ( {x}_{s} ) , \\ m = - 1 & ( 27 ) \\ {f}_{2}^{*} ( {x}_{s} \vert {x}_{r} ) = {{{\frac{{C}_{s - 1}}{( m + 1 ) ( s - r - 1 ) ! {C}_{r - 1}} [ \begin{matrix}{\{ F ( {x}_{r} ) \}}^{m + 1} - \\ {\{ F ( {x}_{s} ) \}}^{m + 1}\end{matrix} ]}^{s - r - 1} [ F ( {x}_{s} ) ]}^{{γ}_{s} - 1} [ F ( {x}_{r} ) ]}^{- {γ}_{r + 1}} f ( {x}_{s} ) , \\ m \neq - 1. & ( 28 )\end{matrix}$$

By substituting equation (3) into equations (27) and (28), we obtain the following two equations:

$$\begin{matrix}{f}_{1}^{*} ( {x}_{s} \vert α , θ ; {x}_{r} ) = \frac{{k}^{s - r} {αθ}^{s - r}}{( s - r - 1 ) !} {{{v}_{s} ( \frac{{u}_{s}}{{u}_{r}} )}^{k θ} [ ln ( \frac{{u}_{r}}{{u}_{s}} ) ]}^{s - r - 1} , m = - 1 , & ( 29 ) \\ {f}_{2}^{*} ( {x}_{s} \vert α , θ ; {x}_{r} ) = \frac{{C}_{s - 1}}{( m + 1 ) ( s - r - 1 ) ! {C}_{r - 1}} αθ {v}_{s} {{u}_{s}^{{θγ}_{s}} [ {u}_{r}^{θ ( m + 1 )} - {u}_{s}^{θ ( m + 1 )} ]}^{s - r - 1} {u}_{r}^{- {θγ}_{r + 1}} , \\ m \neq - 1 , & ( 30 )\end{matrix}$$

In the above equations, the value of the parameter uᵣ can be computed by equation (6). The Bayes predictive density function of Xₛ≡X(s, n, m, k) can be computed as described by Aitchison et al. in “Statistical Prediction Analysis”, Cambridge University Press, and incorporated herein by reference in its entirety as follows:

h(xₛ|x)=∫∫π*(α,θ|x)f*(xₛ|α,θ;xᵣ)dαdθ (31)

Upon substituting equations (18) and (29) into equation (31), we obtain:

$$\begin{matrix}{h}_{1} ( {x}_{s} \vert x ) = {\int }_{0}^{∞} {\int }_{0}^{c} {π}^{*} ( α , θ \vert x ) {f}_{1}^{*} ( {x}_{s} \vert α , θ ; x ) d α d θ , \\ = \frac{{k}^{s - r}}{( s - r - 1 ) !} {k}_{2}^{- 1} Γ ( s ) {\int }_{0}^{c} {v}_{s} {{α}^{r + 1} ( - k ln {u}_{s} )}^{- s} {\prod }_{j = 1}^{r} {v}_{j} \\ {[ ln ( \frac{{u}_{r}}{{u}_{s}} ) ]}^{s - r - 1} d α , m = - 1 , {x}_{s} < {x}_{r} ,\end{matrix} \qquad ( 32 )$$

wherein, we have

$${k}_{2} = Γ ( r ) {\int }_{0}^{c} {α}^{r} {\prod }_{j = 1}^{r} {{v}_{j} ( - k ln {u}_{r} )}^{- r} d α \qquad ( 33 )$$

Furthermore, upon substituting equations (18) and (30) into equation (31), we have:

$$\begin{matrix}{h}_{2} ( {x}_{s} \vert x ) = {\int }_{0}^{∞} {\int }_{0}^{c} {π}^{*} ( α , θ \vert x ) {f}_{2}^{*} ( {x}_{s} \vert α , θ ; x ) d α d θ , \\ \frac{{C}_{s - 1} {k}_{1}^{- 1}}{( m + 1 ) ( s - r - 1 ) ! {C}_{r - 1}} {\int }_{0}^{∞} {\int }_{0}^{c} {v}_{s} {α}^{r + 1} {θ}^{r} {\prod }_{j = 1}^{r} {v}_{j} {e}^{- θ T ( m ; α )} \\ {[ {u}_{r}^{θ ( m + 1 )} - {u}_{s}^{θ ( m + 1 )} ]}^{s - r - 1} {u}_{s}^{{θγ}_{s}} {u}_{r}^{- {θγ}_{r + 1}} d α d θ , \\ m \neq - 1 , {x}_{s} < {x}_{r}\end{matrix} \qquad ( 34 )$$

According to an embodiment, Bayesian prediction bounds for Xₛ can be obtained from equations (32) and (34) by evaluating the following probability for some value v

P(Xₛ≧ν₁|x) (34a)

Therefore, from equation (32), when m=−1, we have the following:

$$\begin{matrix}P ( {X}_{s} \geq {v}_{1} \vert x ) = {\int }_{{v}_{1}}^{{x}_{r}} {h}_{1} ( {x}_{s} \vert x ) d {x}_{s} \\ = \frac{{k}^{s - r} {k}_{2}^{- 1} Γ ( s )}{( s - r - 1 ) !} {\int }_{{v}_{1}}^{{x}_{r}} {\int }_{0}^{c} {v}_{s} {{α}^{r + 1} ( - k ln {u}_{s} )}^{- s} {\prod }_{j = 1}^{r} {v}_{j} \\ {[ ln ( \frac{{u}_{r}}{{u}_{s}} ) ]}^{s - r - 1} d α d {x}_{s} ,\end{matrix} \qquad ( 35 )$$

and when m≠−1, we have the following:

$$\begin{matrix}P ( {X}_{s} \geq {v}_{2} \vert x ) = {\int }_{{v}_{2}}^{{x}_{r}} {h}_{2} ( {x}_{s} \vert x ) d {x}_{s} \\ = \frac{{C}_{s - 1} {k}_{1}^{- 1}}{( m + 1 ) ( s - r - 1 ) ! {C}_{r - 1}} {\int }_{{v}_{2}}^{{x}_{r}} {\int }_{0}^{∞} {\int }_{0}^{c} {v}_{s} {α}^{r + 1} {θ}^{r} \\ {\prod }_{j = 1}^{r} {v}_{j} {e}^{- θ T ( m ; α )} \\ {[ {u}_{r}^{θ ( m + 1 )} - {u}_{s}^{θ ( m + 1 )} ]}^{s - r - 1} {u}_{s}^{{θγ}_{s}} {u}_{r}^{- {θγ}_{r + 1}} d α d θ d {x}_{s} .\end{matrix} \qquad ( 36 )$$

Thus, by one embodiment of the present disclosure we have a 1001% Bayesian prediction interval for Xᵢ such that the following equation is valid:

P(L(x)<Xₛ<U(x))=τ (36)

where L(x) and U(x) are the upper and lower limits satisfying the following condition:

P(Xₛ>L(x)|x)=(1+τ)/2.

P(Xₛ>U(x)|x)=(1−τ)/2. (37)

According to one embodiment of the present disclosure, by substituting m=−1 and k=1, the lower record value can be obtained as a special case from the DGOS. The lower and upper Bayesian prediction bounds for the lower record X(s, n, m, k), s=r+1, r+2, . . . n can be computed from equation (35) and expressed as:

$$\begin{matrix}\begin{matrix}P ( {X}_{s} \geq L ( x ) \vert x ) = \frac{{k}_{2}^{- 1} Γ ( s )}{( s - r - 1 ) !} \\ = {\int }_{0}^{c} {α}^{r} {\prod }_{j = 1}^{r} {v}_{j} {\sum }_{i = 0}^{s - r - 1} \frac{{( - 1 )}^{i - s}}{i - s + 1} ( \begin{matrix}s - r - 1 \\ i\end{matrix} ) \\ {( ln {u}_{r} )}^{s - r - i - 1} [ \begin{matrix}{\{ ln ( 1 - {e}^{- {x}_{r}^{a}} ) \}}^{i - s + 1} - \\ {\{ ln ( 1 - {e}^{- {L}^{a}} ) \}}^{i - s + 1}\end{matrix} ] \\ = ( 1 + r ) / 2\end{matrix} \\ and & ( 38 ) \\ \begin{matrix}P ( {X}_{s} \geq U ( x ) \vert x ) = \frac{{k}_{2}^{- 1} Γ ( s )}{( s - r - 1 ) !} \\ = {\int }_{0}^{c} {α}^{r} {\prod }_{j = 1}^{r} {v}_{j} {\sum }_{i = 0}^{s - r - 1} \frac{{( - 1 )}^{i - s}}{i - s + 1} ( \begin{matrix}s - r - 1 \\ i\end{matrix} ) \\ {( ln {u}_{r} )}^{s - r - i - 1} [ \begin{matrix}{\{ ln ( 1 - {e}^{- {x}_{r}^{a}} ) \}}^{i - s + 1} - \\ {\{ ln ( 1 - {e}^{- {U}^{a}} ) \}}^{i - s + 1}\end{matrix} ] \\ = ( 1 - r ) / 2\end{matrix} & ( 39 )\end{matrix}$$

When s=r+1, the prediction will be for the next lower record value. Upon substituting s=r+1, in equations (38) and (39), the 100τ% lower and upper bounds for Xᵣ₊₁ are computed, respectively, from the following equations:

$$\begin{matrix}P ( {X}_{r + 1} \geq L ( x ) \vert x ) = {k}_{2}^{- 1} Γ ( r + 1 ) {\int }_{0}^{c} {α}^{r} {\prod }_{j = 1}^{r} {v}_{j} \frac{{( - 1 )}^{r}}{r} [ {\{ ln ( 1 - {e}^{- {x}_{r}^{α}} ) \}}^{- r} - {\{ ln ( 1 - {e}^{- {L}^{α}} ) \}}^{- r} ] = ( 1 + τ ) / 2 \\ and & ( 40 ) \\ P ( {X}_{r + 1} \geq U ( x ) \vert x ) = {k}_{2}^{- 1} Γ ( r + 1 ) {\int }_{0}^{c} {α}^{r} {\prod }_{j = 1}^{r} {v}_{j} \frac{{( - 1 )}^{r}}{r} [ {\{ ln ( 1 - {e}^{- {x}_{r}^{α}} ) \}}^{- r} - {\{ ln ( 1 - {e}^{- {U}^{α}} ) \}}^{- r} ] = ( 1 - τ ) / 2 & ( 41 )\end{matrix}$$

According to one embodiment of the present disclosure, since equations (40) and (41) cannot be obtained analytically, a MCMC technique (numerical analysis technique) is employed to compute the bounds of Xᵣ₊₁.

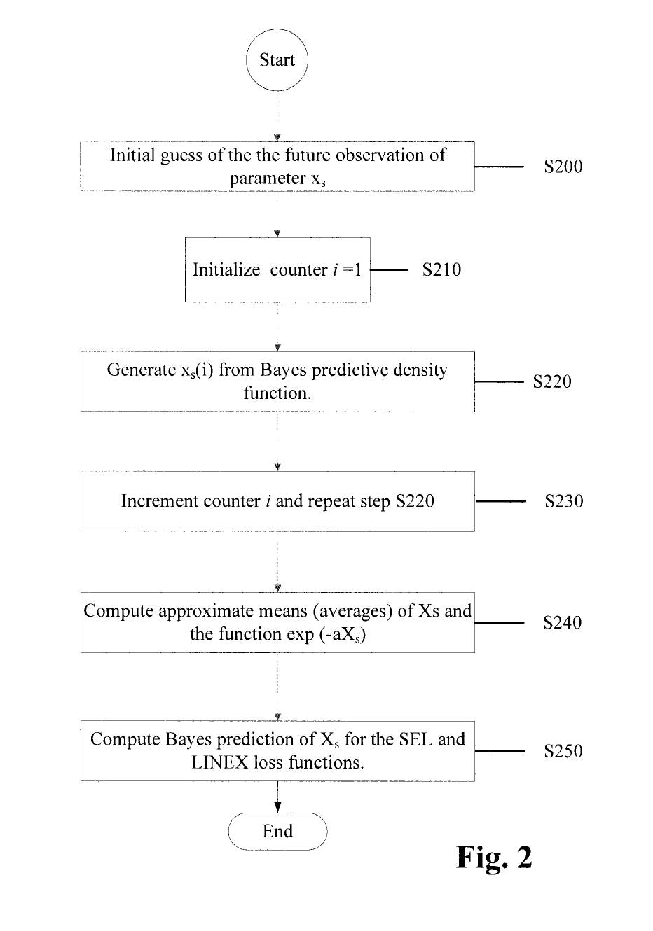

FIG. 2 depicts an exemplary flowchart illustrating the steps performed in computing a Bayes prediction value for a future observation.

In step S200, the process starts with an initial guess (for instance x₀) of the future observation (xₛ). In step S210, the value of the counter i is initialized to one.

The process then proceeds to step S220 wherein, the value of parameter xₛ(i) (also referred to as xₛⁱ) at each level of iteration, is generated based on Bayes predictive density functions as expressed in equations (32) and (34). Specifically, the values of parameter xₛ(i) are generated for the cases of m=−1 and m≠−1, as stated in equations (32) and (34) respectively. The process then proceeds to step S230 wherein the value of the counter i is incremented and the process in step S220 is repeated N times, wherein N is a predetermined integer.

In step S240, the mean (i.e., average) of Xₛ and the function exp (−aXₛ) are computed as follows:

$$E ( {X}_{s} \vert x ) = \frac{1}{N - M} {\sum }_{i = M + 1}^{N} {x}_{s}^{( i )} , \\ E [ exp ( - a {X}_{s} ) \vert x ] = \frac{1}{N - M} {\sum }_{i = M + 1}^{N} exp ( - {ax}_{s}^{( i )} ) \qquad ( 42 )$$

In equation (42), the parameter M corresponds to the burn-in period. Further, the process then process to step S250, wherein the Bayes prediction of Xₛ are computed for each loss function (SEL and LINEX) based on the computed averages of step S240. Specifically, the Bayes prediction corresponding to the SEL and the LINEX loss functions are computed as follows:

$$\begin{matrix}{\hat{x}}_{{s}_{BS}} = E ( {X}_{s} \vert x ) \\ and & ( 43 ) \\ {\hat{x}}_{{s}_{BL}} = - \frac{1}{a} ln [ E [ exp ( - {aX}_{s} ) \vert x ] & ( 44 )\end{matrix}$$

In what follows, according to an embodiment of the present disclosure, a Monte-Carlo simulation study is presented for a comparison of the Bayes and maximum likelihood estimates for the parameters and the reliability function for the EWM distribution. Furthermore, a numerical example is provided for computing the Bayesian prediction bounds for future lower record value X(r+1, n, −1, 1).

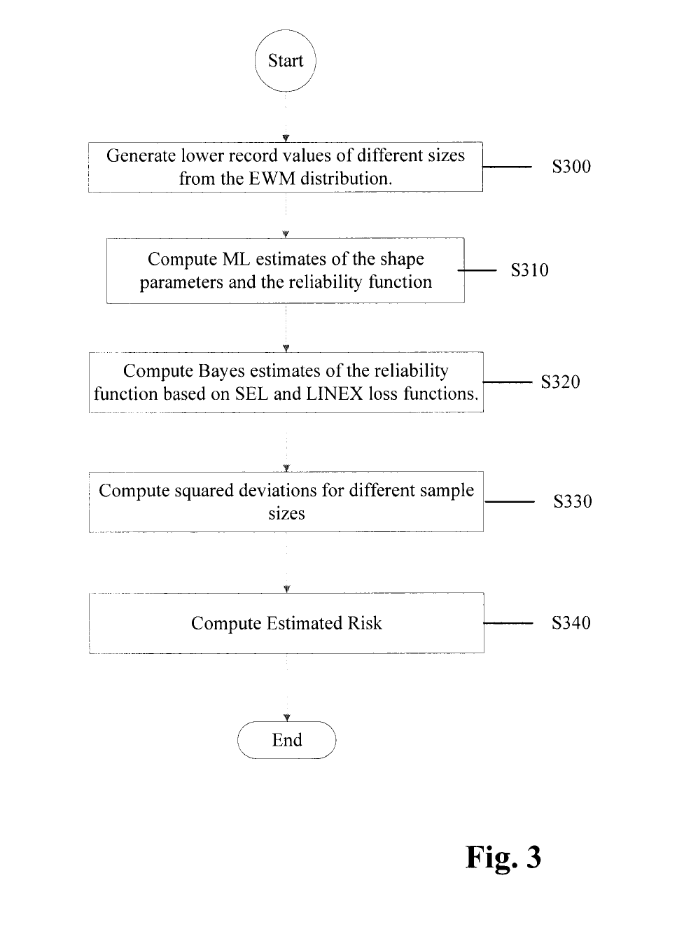

FIG. 3 depicts according to an embodiment, a flowchart illustrating the steps performed in a Monte-Carlo simulation. Specifically, the method illustrated in FIG. 3 describes the steps taken in order to compare the Bayes and maximum-likelihood estimates of the shape parameters and reliability functions of the EWM.

In step S300, for given values of α and θ, lower record values of different sizes are generated from the EWM distribution. The process the moves to step S310, wherein the maximum likelihood (ML) estimates of α and θ are computed by solving equations (8) and (9) with values of m=−1 and k=1. The ML estimate of the reliability function S(t) is computed from equation (4) after replacing α and θ by their ML estimates.

The process then moves to step S320 wherein, based on the desired loss function (SEL and LINEX loss functions), the Bayes estimates of a function ω≡ω(α, θ)=α, θ or S(t) are computed, respectively, from equations (21) and (22), with the values N=15000 (number of iterations) and M=1500 (burn period).

The process then proceeds to step S330, wherein the squared deviations (γ*−γ)² are computed for different sample sizes where (*) stands for an estimate (ML or Bayes) and γ stands for the parameter ω.

In step S340, according to one embodiment, the above steps (S300-S330) are repeated for instance 500 times and the estimated risk (ER) is computed by averaging the squared deviations over the 500 repetitions. The process thereafter terminates.

According to one embodiment, the simulations are performed for the following values: (α=1.5, θ=2.5, and t=1) and (α=2, θ=1.5, and t=1). Tables I and II below depict respectively, the results for estimated risk of the Bayes and ML estimates based on lower record values for the above sets. Note that from Tables I and II, the estimated risks of the estimates decrease as the sample size increases and the Bayes estimates have the smallest estimated risks as compared with their corresponding maximum likelihood estimates.

TABLE I
Estimated risk for Bayes and ML estimates for (α = 1.5, θ = 2.5, and t = 1)
(α = 1.5, θ = 2.5, t = 1)

| | Bayes MCMC Estimation | | | | | |
|---|---|---|---|---|---|---|
| | | LINEX | | | | |
| MLE | SE | α = −5 | α = −2 | α = 2 | α = 3 | α = 5 |

r = 4

| | | | | | | | |
|---|---|---|---|---|---|---|---|
| α | 0.2071 | 0.1436 | 0.1593 | 0.1496 | 0.1381 | 0.1354 | 0.1304 |
| θ | 235.20 | 5.5756 | 34.767 | 24.819 | 1.0292 | 1.0923 | 1.4786 |
| S(t) | 0.0407 | 0.0214 | 0.0240 | 0.0222 | 0.0211 | 0.0213 | 0.0223 |

r = 6

| | | | | | | | |
|---|---|---|---|---|---|---|---|
| α | 0.2007 | 0.0958 | 0.1074 | 0.1002 | 0.0918 | 0.0899 | 0.0864 |
| θ | 8.1789 | 2.4452 | 16.794 | 10.425 | 0.5993 | 0.6685 | 1.0181 |
| S(t) | 0.0358 | 0.0146 | 0.0157 | 0.0148 | 0.0148 | 0.0152 | 0.0163 |

r = 8

| | | | | | | | |
|---|---|---|---|---|---|---|---|
| α | 0.2272 | 0.0813 | 0.0921 | 0.0853 | 0.0776 | 0.0759 | 0.0727 |
| θ | 5.3112 | 1.3266 | 11.229 | 6.3146 | 0.4197 | 0.4704 | 0.7462 |
| S(t) | 0.0318 | 0.0112 | 0.0121 | 0.0114 | 0.0112 | 0.0114 | 0.0119 |

TABLE II
Estimated risk for Bayes and ML estimates for
(α = 2, θ = 1.5, and t = 1)

| | Bayesian MCMC Estmation | | | | | |
|---|---|---|---|---|---|---|
| | | LINEX | | | | |
| MLE | SE | α = −5 | α = −2 | α = 2 | α = 3 | α = 5 |

r = 4

| | | | | | | | |
|---|---|---|---|---|---|---|---|
| α | 0.6690 | 1.5911 | 11.195 | 5.7319 | 0.6665 | 1.0363 | 1.6162 |
| θ | 2.8581 | 1.0348 | 10.909 | 5.7693 | 0.2555 | 0.2616 | 0.3825 |
| S(t) | 0.0507 | 0.0201 | 0.0270 | 0.0222 | 0.0187 | 0.0184 | 0.0183 |

r = 6

| | | | | | | | |
|---|---|---|---|---|---|---|---|
| α | 0.3937 | 0.9741 | 5.9998 | 2.7628 | 0.3367 | 0.2728 | 0.3332 |
| θ | 1.9088 | 0.6628 | 7.0695 | 3.4324 | 0.2029 | 0.2180 | 0.2924 |
| S(t) | 0.0409 | 0.0145 | 0.0192 | 0.0159 | 0.0137 | 0.0136 | 0.0137 |

r = 8

| | | | | | | | |
|---|---|---|---|---|---|---|---|
| α | 0.2848 | 0.6667 | 5.9997 | 2.6173 | 0.1974 | 0.1789 | 0.2498 |
| θ | 1.5837 | 0.4010 | 4.6137 | 1.9081 | 0.2028 | 0.2149 | 0.2874 |
| S(t) | 0.0307 | 0.0111 | 0.0126 | 0.0112 | 0.0114 | 0.0118 | 0.0128 |

According to another embodiment of the present disclosure, for given values of α=2.5 and θ=1.5, ten lower record values generated from the exponentiated Weibull distribution are as follows: {2.1485; 0.8881; 0.6752; 0.5583; 4627; 0.4425; 0.2937; 0.2326; 0.2262; 0.1674}

Using the results with τ=0.95 and c=2, the Bayes point prediction of X₁₁ is 0.1667 based on the squared error loss function. Further, under the LINEX loss function, the Bayes point prediction of X₁₁ is equal 0.1668 when a=−2, and equal 0.1666 at a=2. Also, using the same set of data considered above, the 95% Bayesian prediction interval for X₁₁ is (0.1481; 0.1853).

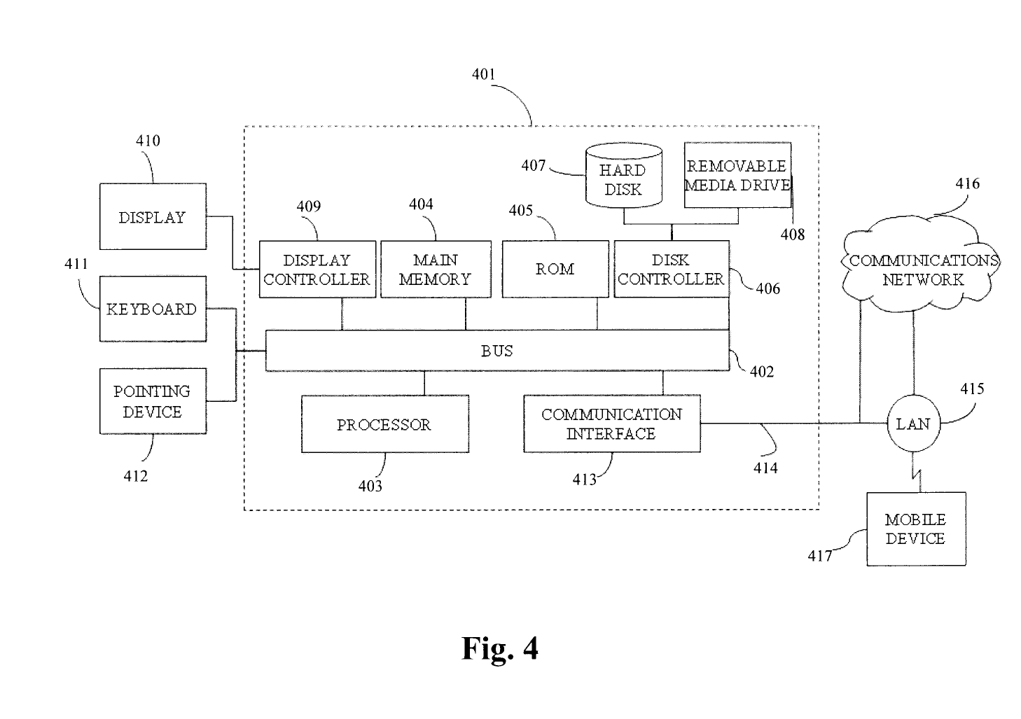

Each of the functions of the described embodiments may be implemented by one or more processing circuits. A processing circuit includes a programmed processor (for example, processor 403 in FIG. 4), as a processor includes circuitry. A processing circuit also includes devices such as an application-specific integrated circuit (ASIC) and circuit components arranged to perform the recited functions.

The various features discussed above may be implemented by a computer system (or programmable logic). FIG. 4 illustrates such a computer system 401. The computer system 401 includes a disk controller 406 coupled to the bus 402 to control one or more storage devices for storing information and instructions, such as a magnetic hard disk 407, and a removable media drive 408 (e.g., floppy disk drive, read-only compact disc drive, read/write compact disc drive, compact disc jukebox, tape drive, and removable magneto-optical drive). The storage devices may be added to the computer system 401 using an appropriate device interface (e.g., small computer system interface (SCSI), integrated device electronics (IDE), enhanced-IDE (E-IDE), direct memory access (DMA), or ultra-DMA).

The computer system 401 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 401 may also include a display controller 409 coupled to the bus 402 to control a display 410, for displaying information to a computer user. The computer system includes input devices, such as a keyboard 411 and a pointing device 412, for interacting with a computer user and providing information to the processor 403. The pointing device 412, for example, may be a mouse, a trackball, a finger for a touch screen sensor, or a pointing stick for communicating direction information and command selections to the processor 403 and for controlling cursor movement on the display 410.

The processor 403 executes one or more sequences of one or more instructions contained in a memory, such as the main memory 404. Such instructions may be read into the main memory 404 from another computer readable medium, such as a hard disk 407 or a removable media drive 408. One or more processors in a multi-processing arrangement may also be employed to execute the sequences of instructions contained in main memory 404. In alternative embodiments, hard-wired circuitry may be used in place of or in combination with software instructions. Thus, embodiments are not limited to any specific combination of hardware circuitry and software.

As stated above, the computer system 401 includes at least one computer readable medium or memory for holding instructions programmed according to any of the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 401, for driving a device or devices for implementing the invention, and for enabling the computer system 401 to interact with a human user. Such software may include, but is not limited to, device drivers, operating systems, and applications software. Such computer readable media further includes the computer program product of the present disclosure for performing all or a portion (if processing is distributed) of the processing performed in implementing any portion of the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 403 for execution. A computer readable medium may take many forms, including but not limited to, non-volatile media or volatile media. Non-volatile media includes, for example, optical, magnetic disks, and magneto-optical disks, such as the hard disk 407 or the removable media drive 408. Volatile media includes dynamic memory, such as the main memory 404. Transmission media, on the contrary, includes coaxial cables, copper wire and fiber optics, including the wires that make up the bus 402. Transmission media also may also take the form of acoustic or light waves, such as those generated during radio wave and infrared data communications.

Various forms of computer readable media may be involved in carrying out one or more sequences of one or more instructions to processor 403 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 401 may receive the data on the telephone line and place the data on the bus 402. The bus 402 carries the data to the main memory 404, from which the processor 403 retrieves and executes the instructions. The instructions received by the main memory 404 may optionally be stored on storage device 407 or 408 either before or after execution by processor 403.

The computer system 401 also includes a communication interface 413 coupled to the bus 402. The communication interface 413 provides a two-way data communication coupling to a network link 414 that is connected to, for example, a local area network (LAN) 415, or to another communications network 416 such as the Internet. For example, the communication interface 413 may be a network interface card to attach to any packet switched LAN. As another example, the communication interface 413 may be an integrated services digital network (ISDN) card. Wireless links may also be implemented. In any such implementation, the communication interface 413 sends and receives electrical, electromagnetic or optical signals that carry digital data streams representing various types of information.

The network link 414 typically provides data communication through one or more networks to other data devices. For example, the network link 414 may provide a connection to another computer through a local network 415 (e.g., a LAN) or through equipment operated by a service provider, which provides communication services through a communications network 416. The local network 414 and the communications network 416 use, for example, electrical, electromagnetic, or optical signals that carry digital data streams, and the associated physical layer (e.g., CAT 5 cable, coaxial cable, optical fiber, etc.). The signals through the various networks and the signals on the network link 414 and through the communication interface 413, which carry the digital data to and from the computer system 401 may be implemented in baseband signals, or carrier wave based signals.

The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 401 can transmit and receive data, including program code, through the network(s) 415 and 416, the network link 414 and the communication interface 413. Moreover, the network link 414 may provide a connection through a LAN 415 to a mobile device 417 such as a personal digital assistant (PDA) laptop computer, or cellular telephone.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below. Furthermore, the above disclosure also encompasses the embodiments noted below.

1. A method of estimating shape parameters and a reliability function of an exponentiated Weibull model (EWM) based on dual generalized order statistics of the model, the method comprising:
assigning an initial value for each of a first shape parameter and a second shape parameter of the EWM;
generating by circuitry, a predetermined number of samples for each of the first shape parameter and the second shape parameter based on a first conditional posterior distribution of the first shape parameter with respect to the second shape parameter and a second conditional posterior distribution of the second shape parameter with respect to the first shape parameter;
calculating based on the generated samples and a burn-in period, Bayesian estimates of the first shape parameter, the second shape parameter, and the reliability function of the EWM corresponding to a loss function;
computing by circuitry, maximum likelihood estimates of the first shape parameter, the second shape parameter and the reliability function of the EWM;
computing squared error deviations for each of the computed Bayesian estimates and maximum likelihood estimates; and
computing an estimated risk of the first shape parameter, the second shape parameter and the reliability function based on the computed squared error deviations.

2. The method of claim 1, further comprising:
computing by circuitry, confidence intervals of the first shape parameter and the second shape parameter based on a variance-covariance matrix of the computed maximum likelihood estimates of the first shape parameter and the second shape parameter.

3. The method of claim 1, wherein the loss function is one of a symmetric squared error loss function and an asymmetric linear exponential loss function.

4. The method of claim 1, wherein the generating step further comprises:
computing by circuitry, a first average of the generated samples of the first shape parameter and a second average of the generated samples of the second shape parameter.

5. The method of claim 1, wherein the burn-in period corresponds to a number samples from the predetermined number of samples that are ignored.

6. The method of claim 1, wherein the predetermined number of samples is 15000 and the burn-in period is 1500 samples.

7. The method of claim 1 further comprising:
predicting a future observation of the EWM based on the generated samples and the computed Bayesian estimates.

8. A non-transitory computer-readable medium having stored thereon a program that, when executed by a computer, causes the computer to execute a method comprising:
assigning an initial value for each of a first shape parameter and a second shape parameter of the EWM;
generating a predetermined number of samples for each of the first shape parameter and the second shape parameter based on a first conditional posterior distribution of the first shape parameter with respect to the second shape parameter and a second conditional posterior distribution of the second shape parameter with respect to the first shape parameter;
calculating based on the generated samples and a burn-in period, Bayesian estimates of the first shape parameter, the second shape parameter, and the reliability function of the EWM corresponding to a loss function;
computing maximum likelihood estimates of the first shape parameter, the second shape parameter and the reliability function of the EWM;
computing squared error deviations for each of the computed Bayesian estimates and maximum likelihood estimates; and
computing an estimated risk of the first shape parameter, the second shape parameter and the reliability function based on the computed squared error deviations.

9. The non-transitory computer-readable medium of claim 8, the method further comprising:
computing confidence intervals of the first shape parameter and the second shape parameter based on a variance-covariance matrix of the computed maximum likelihood estimates of the first shape parameter and the second shape parameter.

10. The non-transitory computer-readable medium of claim 8, wherein the loss function is one of a symmetric squared error loss function and an asymmetric linear exponential loss function.

11. The non-transitory computer-readable medium of claim 8, wherein the generating step further comprises:
computing by circuitry, a first average of the generated samples of the first shape parameter and a second average of the generated samples of the second shape parameter.

12. The non-transitory computer-readable medium of claim 8, wherein the burn-in period corresponds to a number samples from the predetermined number of samples that are ignored.

13. The non-transitory computer-readable medium of claim 8, wherein the predetermined number of samples is 15000 and the burn-in period is 1500 samples.

14. The non-transitory computer-readable medium of claim 8, the method further comprising:
predicting a future observation of the EWM based on the generated samples and the computed Bayesian estimates.

16. A device for estimating shape parameters and a reliability function of an exponentiated Weibull model (EWM) based on dual generalized order statistics of the model, the device comprising:
circuitry configured to
assign an initial value for each of a first shape parameter and a second shape parameter of the EWM,
generate a predetermined number of samples for each of the first shape parameter and the second shape parameter based on a first conditional posterior distribution of the first shape parameter with respect to the second shape parameter and a second conditional posterior distribution of the second shape parameter with respect to the first shape parameter,
calculate based on the generated samples and a burn-in period, Bayesian estimates of the first shape parameter, the second shape parameter, and the reliability function of the EWM corresponding to a loss function,
compute maximum likelihood estimates of the first shape parameter, the second shape parameter and the reliability function of the EWM,
compute squared error deviations for each of the computed Bayesian estimates and maximum likelihood estimates, and
compute an estimated risk of the first shape parameter, the second shape parameter and the reliability function based on the computed squared error deviations.

17. The device of claim 16, wherein the circuitry is further configured to:
compute confidence intervals of the first shape parameter and the second shape parameter based on a variance-covariance matrix of the computed maximum likelihood estimates of the first shape parameter and the second shape parameter.

18. The device of claim 16, wherein the loss function is one of a symmetric squared error loss function and an asymmetric linear exponential loss function.

19. The device of claim 16, wherein the burn-in period corresponds to a number samples from the predetermined number of samples that are ignored.

20. The device of claim 16, wherein the circuitry is further configured to:
predict a future observation of the EWM based on the generated samples and the computed Bayesian estimates.
